(19) United States
(12) Patent Application Publication
(10) Pub. No.: US 2004/0144250 A1
(43) Pub. Date: Jul. 29, 2004

(54) Sorption agent and method for removing heavy metals from a gas containing heavy metals

(75) Inventors: Gabriele Neuroth, Maintal (DE); Wolfgang Willing, Wollstadt (DE); Lutz-Peter Nethe, Potsdam (DE); Holger Fuchs, Wehrheim (DE); Ralf Neumann, Frankfurt Am Main (DE)

Correspondence Address: WILLIAM COLLARD, COLLARD & ROE, P.C., 1077 NORTHERN BOULEVARD, ROSLYN, NY, 11576, US

(73) Assignee: Donau Carbon GmbH & Co.KG

(21) Appl. No.: 10/662,897

(22) Filed: Sep. 15, 2003

(30) Foreign Application Priority Data
Jan. 25, 2003 (DE) 103 02 978.8

(51) Int. Cl. B01D 53/02

(52) U.S. Cl. 95/133

(57) ABSTRACT

Sorption agent and method for removing heavy metals from a gas containing heavy metal(s), with which a better removal rate of heavy metals from gases containing heavy metal(s) is made possible, and which can also be used in a broad temperature range. This is achieved in that the sorption agent contains at least one solid, which is a carrier material onto which at least one polysulfide is fixed and, in the case of the method, in which the gas containing heavy metal(s) is brought into contact with a sorption agent. A sorption agent is used that contains at least one solid, which is a carrier material onto which at least one polysulfide is fixed.

### BACKGROUND OF THE INVENTION

1. Field of the Invention

The present invention relates to a sorption agent for removing heavy metals from a gas containing heavy metal(s), as well as to a corresponding method, in which the gas containing heavy metal(s) is brought into contact with a sorption agent.

2. The Prior Art

In a large number of technical processes, for example in the pyrolysis of waste, as well as in the production of pharmaceuticals and foods, gases are formed that contain significant amounts of heavy metals, such as mercury, cadmium and/or the like. In order to keep environmental pollution caused by such processes as low as possible, and in order to adhere to the applicable waste gas limit values, these gases must be treated before being released to the atmosphere.

In order to remove heavy metals from waste gas, fixed bed filter processes and gas stream processes are used. While in the processes mentioned first, the gases to be purified are passed through solid filters that contain sorption agents. In the processes mentioned last, the substances that absorb the heavy metals are sprayed directly into the gas stream. In this connection, a sorption agent is understood to mean a substance that meets at least one of the following characteristics, namely one that binds the metals to be removed to the sorption agent either by chemisorption, by chemical reaction with the sorption agent, by adsorption and/or by absorption. Usually, a mixture of activated carbon and sulfur, or activated carbon impregnated with sulfur is used.

A method for removing mercury and mercury compounds from hot waste gas that contains sulfur compounds is known from DE 43 39 072 A1. In this method activated carbon or open-hearth furnace coke, without sulfur impregnation, in each instance, is used in a mixture with a solid that is chemically inert with regard to the sulfur compounds contained in the waste gas, preferably limestone powder. In this way, the use of sulfur-impregnated activated charcoal, which is relatively expensive as compared with conventional activated carbon, can be eliminated. While the activated carbon results in sorption of the mercury by the activated carbon, together with the sulfur compounds contained in the waste gas, the solid that is chemically inert with regard to the sulfur compounds is supposed to raise the ignition point of the mixture. Using this method, it is supposed to be possible to remove up to 95% of the mercury contained in the gas to be purified. However, this removal rate is not sufficiently high for most applications. Another disadvantage of the method is that its applicability is limited to waste gas that contains sulfur compounds.

DE 44 37 781 A1 discloses a method for removing mercury from waste gas that contains dust and mercury, in which an aqueous sodium tetrasulfide solution is sprayed into the gas to be purified. The mercury sulfide that forms from sodium tetrasulfide and mercury is removed from the gas by means of a dust filter, preferably a filter made of a woven material. A significant disadvantage of this method is that a certain dust concentration has to be adjusted in the gas stream, in order to achieve a noteworthy removal of mercury. Furthermore, the removal rates of about 95% that can be achieved with this method as well need improvement. According to the current regulations, such as the “Technische Anleitung Luft” [Technical Regulations for Air], the limit values that are required for the emission of heavy metals cannot be met with the removal rate of 95% indicated therein.

Finally, a sorption agent for removing mercury vapor from gas that contains mercury is known from U.S. Pat. No. 4,500,327, containing activated carbon, to the surface of which at least two different compounds are applied. These at least two compounds are selected from one of three different groups, in each instance. The first group consists of sulfur, the second group consists of ammonium sulfates and nitrates, and certain metal sulfates as well as nitrates, and the third group consists of ammonium iodides and bromides, and certain alkali metal iodides and bromides, as well as oxidated iodides and bromides of ammonium and certain alkali metals. According to this disclosure, these sorption agents having at least two compounds from two different groups of the ones indicated above are supposed to demonstrate a higher removal rate of mercury from gas containing mercury than sorption agents with one or more compounds from only one of the stated groups. Depending on the combination and the quantitative ratio of the at least two compounds, these sorption agents are supposed to allow a removal rate of 80 to 100% after five hours. A disadvantage of this method, however, is that two different compounds must be applied to the carrier material in a certain quantitative relationship with one another. Thus, as a whole this method demands a complicated and unreasonably expensive production process, depending on the compounds selected.

### SUMMARY OF THE INVENTION

It is therefore an object of the present invention to make available a sorption agent and a method, which allow a better removal rate of heavy metals from gases containing heavy metal(s), which are easier and/or more cost-effective and, in particular, can be used in a broad temperature range, as compared with the known agents and methods.

This object is achieved by means of a sorption agent comprising at least one solid comprising a carrier material onto which at least one polysulfide is fixed as well as a method making use of such a sorption agent.

Surprisingly, the sorption agents according to the invention achieve a removal rate of heavy metals from corresponding gases that contain heavy metal(s), at more than 99%. In particular, the sorption agents according to the present invention have proven themselves to be suitable for removing mercury from gases that contain mercury, whereby not only metallic mercury, but also ionic mercury is removed at high rates. However, the sorption agents can also be used to remove other heavy metals, such as cadmium or the like, from corresponding gases. Another advantage of the sorption agents according to the present invention, particularly as compared with those sorption agents that are impregnated/doped with elemental sulfur, is that they can be used in a broad temperature range. In particular, they can be used also at high temperatures, at which elemental sulfur is readily desorbed from the carrier material of the known sorption agents containing sulfur, and gets into the environment in elemental or oxidized form. To prevent emissions, additional process steps are required in connection with the known sorption agents. Another advantage of the sorption agents according to the present invention is their simple and cost-effective production in only a single doping step.

According to the present invention, the at least one solid of the sorption agent comprises a carrier material onto which at least one polysulfide is fixed. A polysulfide in the sense of the present invention is understood to be a compound with the general formula KSₓ, whereby K is any cation and x is any whole number greater than 1. Fixed in the sense of the present invention means that the polysulfide or the polysulfides is/are applied to the surface of the carrier material and connected/with the latter, for example by means of sorption, by means of chemical bonding, or other forces.

Fundamentally, one polysulfide or several different polysulfides can be fixed onto the carrier material of the sorption agent, whereby one polysulfide fixed onto the carrier material is preferred, because of the ease of production.

Preferably, the polysulfide fixed onto the carrier material is selected from the group that consists of lithium, sodium, potassium, rubidium, cesium, calcium, magnesium, barium, ammonium and organic amine polysulfides. In principle, however, any polysulfide known to a person skilled in the art can be used.

Good properties in terms of applications technology are achieved if one or more polysulfides are fixed onto the carrier material of the sorption agent at between 0.5 and 50 wt.-%, preferably between 1 and 20 wt.-%. Each percent by weight is based upon the total weight of the carrier material and the polysulfide.

As a further embodiment of the present invention, it is proposed to use a porous carrier material. In this manner, sorption agents with a high capacity and, at the same time, a high removal rate are obtained. In this connection, according to the invention, the carrier material has a BET surface of 100 to 2,000 m²/g and, in a preferred embodiment, from 500 to 800 m²/g.

Fundamentally, any substance known to a person skilled in the art to be suitable as a carrier material can be used. However, sorption agents with particularly good properties in terms of applications technology are obtained if the carrier material is pumice, clay, activated carbon, or a mixture of two or more of the aforementioned substances.

Preferably, the grain size of the carrier material is between 1 μm and 10 mm, and more preferably between 10 μm and 40 μm, as well as between 2 mm and 5 mm.

According to another embodiment of the present invention, the sorption agent comprises only one solid made of a carrier material onto which a polysulfide or several different polysulfides are fixed.

According to yet another embodiment of the present invention, the sorption agent contains not only a solid made of a carrier material onto which a polysulfide or several different polysulfides are fixed, but also at least one other solid. This other solid can, in turn, comprise a carrier material onto which a polysulfide or several different polysulfides are fixed, whereby the carrier material and/or the polysulfides fixed onto it are different from those of the first solid. However, another solid that comprises only a carrier material, without any polysulfides fixed onto it, or of an inert material, is preferred. Hydrophobic materials are particularly suitable as inert materials, for example silicate stones, lava, slag, vitrification residues, or fine gravel. Such inert materials and others suitable for the sorption agent according to the invention are described, for example, in EP 0 808 650 B1, which is herewith incorporated by reference, and is considered to be part of the disclosure.

In order to produce the sorption agent according to the invention, the polysulfide or the polysulfides are sprayed onto the carrier material, for example. The process is conducted at room temperature, in order to minimize the undesirable release of gaseous products. Subsequent heating to dry the sorption agent is only required if the water content of the sorption agent is too greatly increased by the application of the sulfide component(s).

Another object of the present invention is to provide a method for removing heavy metals from a gas containing heavy metal(s), in which the gas containing heavy metal(s) is brought into contact with a sorption agent, in which a sorption agent containing at least one solid, comprising a carrier material onto which at least one polysulfide is fixed, is used.

Surprisingly, a high removal rate of heavy metals from corresponding gases containing heavy metal(s) is achieved using the method according to the invention, which rate is usually greater than 99%. In particular, the method is suitable for removing mercury from gases containing mercury, whereby not only metallic mercury, but also ionic mercury is removed at high rates of more than 99%. Because of the high removal rates, it is not necessary to use a second purification step, as it is regularly provided in the prior art methods currently known. Because polysulfides fixed onto the carrier material are used, the sorption material can be recirculated without any losses in effectiveness and, at the same time, it is not necessary to spray sulfur compounds into the gas phase. In this manner, it is guaranteed that no sulfur compounds will get into the environment. Another advantage of the method according to the invention, particularly as compared with those in which sorption agents impregnated/doped with elemental sulfur are used, is that it can be carried out in a broad temperature range, particularly also at high temperatures, at which elemental sulfur is readily desorbed from the carrier material of the known sorption agents that contain sulfur, and gets into the environment. This again reliably guarantees that no sulfur compounds will get into the environment.

Preferably, the method according to the invention is carried out as a fixed bed process or as a gas stream process. While in the case of fixed bed process mentioned first, the sorption agent is placed into an absorber or the like and the gas to be purified flows through the absorber. In the case of the gas stream process mentioned second, the sorption agent is injected into the gas stream and the sorption agent that has been introduced is removed from the gas stream, together with the heavy metal compounds that have been removed, after a predetermined reaction distance, in a filter. In the case of the type of method mentioned last, the sorption agent is preferably introduced into the gas stream to be purified in the form of a powder, at a grain size of 1 μm to 200 μm, and particularly preferably at a grain size of 10 μm to 40 μm. Aside from these two types of processes, the sorption agent can, of course, be brought into contact with the gas stream in any other manner known to a person skilled in the art.

Fundamentally, sorption agents having one or more different polysulfides fixed onto the carrier material can be used in the method according to the invention. However sorption agents having one polysulfide fixed onto the carrier material are preferred, because of their ease of production.

Preferably, the polysulfide fixed onto the carrier material is selected from the group that consists of lithium, sodium, potassium, rubidium, cesium, calcium, magnesium, barium, ammonium and organic amine polysulfides. In principle, however, any polysulfide known to a person skilled in the art can be used.

Good results, particularly high removal rates, are achieved if a sorption agent having 0.5 to 50 wt.-%, and particularly 1 to 20 wt.-%, based upon the total weight of the carrier material and the polysulfide, of one or more polysulfides fixed onto the carrier material is used.

As a further embodiment of the present invention, it is proposed to use a porous carrier material, since these sorption agents have a high capacity. In this connection, a carrier material having a BET surface of 100 to 2,000 m²/g and, in particular, from 500 to 800 m²/g, is preferred.

Fundamentally, any substance known to a person skilled in the art to be suitable as a carrier material can be used. However, sorption agents with particularly good properties in terms of applications technology are obtained if the carrier material is pumice, clay, activated carbon, or a mixture of two or more of the aforementioned substances.

Preferably, the range of the grain sizes of the carrier material is between 1 μm and 10 mm. Particularly preferred grain sizes are between 1 μm and 200 μm, and very particularly preferred grain sizes are between 10 μm and 40 μm, as well as between 2 mm and 5 mm.

According to another embodiment of the present invention, sorption agents consisting of only one solid made of a carrier material onto which a polysulfide or several different polysulfides are fixed are used for the method.

According to another embodiment of the present invention, sorption agents can also be used that contain not only a first solid made of a carrier material onto which a polysulfide or several different polysulfides are fixed, but also at least one other or second solid. This other or second solid can, in turn, consist of a carrier material onto which a polysulfide or several different polysulfides are fixed, whereby the carrier material and/or the polysulfides fixed onto it are different from those of the first solid. However, another or second solid that consists only of a carrier material, without any polysulfides fixed onto it, or of an inert material, is preferred.

In the following, the present invention will be explained using examples that demonstrate the idea of the invention, but do not restrict it:

### DETAILED DESCRIPTION OF PREFERRED EMBODIMENTS

### EXAMPLE 1

Activated carbon with a BET surface of 800 m²/g, onto which 4 wt.-% sodium tetrasulfide was fixed, with reference to the total weight of the doped activated carbon, was placed in an absorber. The expanse of the layer of sorption agent in the absorber was about 60 cm. A hot gas containing 1,000 μg/m³ mercury was allowed to flow through this layer, at a flow speed of about 30 cm/sec. The temperature of the absorber was approximately 140° C., because of the hot gases.

At the exit from the absorber, the mercury content of the purified gas was clearly less than 10 μg/m³, corresponding to a removal rate of mercury in the absorber of clearly more than 99%.

### EXAMPLE 2

A sorption agent consisting of a carrier material made of a mixture of clay and pumice in a weight ratio of 50:50, onto which 0.5 wt.-% sodium tetrasulfide was fixed, with reference to the total weight of the sorption agent, was placed in an absorber, whereby the expanse of the layer of sorption agent in the absorber was about 60 cm. A gas containing 500 μg/m³ mercury, at a temperature of about 40° C., was allowed to flow through this layer, at a flow speed of about 30 cm/sec.

At the exit from the absorber, the mercury content of the purified gas was clearly less than 5 μg/m³, corresponding to a removal rate of mercury in the absorber of more than 99%.

Examples 2 and 3 show that good removal rates of mercury can be achieved not only with activated carbon, but also with other carrier materials.

### EXAMPLE 3

Activated carbon with sodium tetrasulfide fixed onto it according to Example 1 was mixed with pumice as an inert material, in a weight ratio of 50:50, and placed in an absorber with a layer thickness of about 60 cm. A hot gas, at a temperature of 220° C., containing 400 μg/m³ mercury, was allowed to flow through at a flow speed of about 30 cm/sec.

At the exit from the absorber, the mercury content of the purified gas was less than 4 μg/m³, corresponding to a removal rate of mercury in the absorber of more than 99%. It was possible to reduce the fire load by means of the mixture with the inert material.

### EXAMPLE 4

Activated carbon with sodium tetrasulfide fixed onto it according to Example 1 was ground to a powder having a grain size of about 40 μm and introduced, in an amount of 5 g/m³, into a gas stream containing 200 μg/m³ mercury. After a distance of 10 m, the gas stream was passed through a filter, in order to remove the solids obtained.

After the filter, the mercury content of the purified gas was less than 20 μg/m³, corresponding to a removal rate of mercury of more than 90%.

This example shows that high removal rates can be achieved, using the method according to the invention, not only in the fixed bed process, but also in the gas stream process.

### EXAMPLE 5

Activated carbon with sodium tetrasulfide fixed onto it according to Example 1 was placed in a fixed bed and hot gas containing 150 μg/m³ cadmium, at a temperature of 200° C., was allowed to flow through. After a distance of 60 cm, the cadmium content of the purified gas was less than 30 μg/m³, corresponding to a removal rate of cadmium of more than 80%.

### EXAMPLE 6

In a large-scale absorber, the fixed bed process was used with the sorption agent according to Example 1. The treated gas volumes were 1.5 million Nm³/h (f) at a mercury content of about 1000 μg/Nm³ (f). After the gas flowed through the sorption agent, which was used at a layer thickness of 100 cm, the mercury content was less than 30 μg/Nm³ (tr).

Accordingly, while a few embodiments of the present invention have been shown and described, it is to be understood that many changes and modifications may be made thereunto without departing from the spirit and scope of the invention as defined in the appended claims.

What is claimed is:

1. Sorption agent for removing a heavy metal from a gas containing a heavy metal, comprising
at least one solid comprising a carrier material onto which at least one polysulfide is fixed.

2. Sorption agent according to claim 1,
wherein the at least one polysulfide is selected from the group consisting of lithium, sodium, potassium, rubidium, cesium, calcium, magnesium, barium, ammonium and organic amine polysulfides.

3. Sorption agent according to claim 1,
wherein the amount of polysulfide is selected from the group consisting of 0.5 to 50 wt.-%, and 1 to 20 wt.-% of at least one polysulfide, with reference to the total weight of the carrier material and the polysulfide, and said polysulfide being fixed onto the carrier material.

4. Sorption agent according claim 1,
wherein the carrier material is porous.

5. Sorption agent according to claim 4,
wherein the carrier material has a BET surface selected from the group consisting of 100 to 2,000 m²/g and, from 500 to 800 m²/g.

6. Sorption agent according to claim 1,
wherein the carrier material is selected from the group consisting of pumice, clay, activated carbon, and a mixture of al least two of these materials.

7. Sorption agent according to claim 1,
wherein the carrier material has a grain size selected from the group consisting of between 1 μm and 10 mm, between 10 μm and 40 μm, and between 2 mm and 5 mm.

8. Sorption agent according to claim 1,
wherein the sorption agent contains not only a first solid made of a carrier material, but also at least one other second solid.

9. Sorption agent according to claim 8,
wherein the at least one other second solid is selected from the group consisting of a carrier material onto which no polysulfide is fixed, an inert material, and a mixture thereof.

10. Method for removing a heavy metal from a gas containing a heavy metal comprising
bringing the gas containing the heavy metal into contact with a sorption agent; and
using a sorption agent that contains at least one solid comprising a carrier material onto which at least one polysulfide is fixed.

11. Method according to claim 10, comprising
conducting it in a manner selected from the group consisting of a fixed bed process and a gas stream process.

12. Method according to claim 10,
wherein the at least one polysulfide is selected from the group consisting of lithium, sodium, potassium, rubidium, cesium, calcium, magnesium, barium, ammonium and organic amine polysulfides.

13. Method according to claim 10,
wherein the amount of polysulfide is selected from the group consisting of 0.5 to 50 wt.-%, and 1 to 20 wt.-% of at least one polysulfide, with reference to the total weight of the carrier material and the polysulfide, and is fixed onto the carrier material.

14. Method according to claim 10,
wherein the carrier material is porous.

15. Method according to claim 12,
wherein the carrier material has a BET surface of 100 to 2,000 m²/g.

16. Method according to claim 10,
wherein the carrier material is selected from the group consisting of pumice, clay, activated carbon, and a mixture of at least two of these materials.

17. Sorption agent according to claim 7,
wherein the grain size of the carrier material is between 1 μm and 10 mm.

18. Sorption agent according to claim 17,
wherein the grain size of the carrier material is selected from the group consisting of between 1 μm and 200 μm, between 10 μm and 40 μm, and between 2 mm and 5 mm.

19. Method according to claim 10,
wherein the method contains not only a first solid, but also at least one other second solid.

20. Method according to claim 19,
wherein the at least one other second solid is selected from the group consisting of a carrier material onto which no polysulfide is fixed, an inert material, and a mixture thereof.
